(19) United States
(12) Patent Application Publication
(10) Pub. No.: US 2018/0053964 A1
(43) Pub. Date: Feb. 22, 2018

(54) Transient electronic device

(71) Applicant: Iowa State University Research Foundation, Inc., Ames, IA (US)

(72) Inventors: Reza Montazami, Ames, IA (US); Nastaran Hashemi, Ames, IA (US)

(73) Assignee: Iowa State University Research Foundation, Inc.

(21) Appl. No.: 15/731,846

(22) Filed: Aug. 14, 2017

Related U.S. Application Data
(60) Provisional application No. 62/494,751, filed on Aug. 18, 2016.

(51) Int. Cl. H01M 10/0525; H01M 10/42

(52) U.S. Cl. CPC H01M 10/0525; H01M 10/4235

(57) ABSTRACT

A transient electronic device is provided having a transient substrate with an electronic component constructed thereon. The electronic component comprises colloidal metallic particles that are initially deposited from a colloidal dispersion on the substrate to construct the electronic component thereon and that are subsequently re-dispersible by contact with a solvent-containing medium to deconstruct the electronic component of the electronic device. The device can be a lithium ion battery.

### RELATED APPLICATION

This application claims benefit and priority of provisional application Ser. No. 62/494,751 filed Aug. 18, 2016, the disclosure and drawings of which are incorporated herein by reference.

### FIELD OF THE INVENTION

The present invention relates to transient electronic devices which are designed to operate over a typically short and well-defined duration of time and then undergo self-deconstruction and inoperability when no further needed.

### BACKGROUND OF THE INVENTION

Unlike conventional electronics that are designed to last for extensive periods of time, a key and unique attribute of transient electronics is to operate over a typically short and well-defined period; and undergo fast and, ideally, complete self-deconstruction and vanish when transiency is triggered. Transient electronics have a wide range of potential applications including those in healthcare, biomedical devices, environmental sensing/monitoring, green electronics, military and homeland security, to name a few examples.Transient electronics is an emerging class of technology representing materials that are able to vanish in a controlled manner when exposed to a stimuli. Unlike conventional electronic devices that are designed to operate over the longest possible duration of time, a defining attribute of transient electronics is to operate over a typically short and well-defined duration of time and undergo self-deconstruction and disappear completely when no further needed.

To date, transiency triggered by exposure to light, heat, or solvent (often aqueous) has been reported. Due to their potential applications in biomedical implants, temporary environmental sensors/monitors, “green” electronics, hardware security and military applications, aqueous solvent-triggered transient devices are by far the most studied systems. Depending on the application and design of transient electronic devices transiency can be triggered and stimulated by exposure to water, water-based solvents or bodily fluids (phosphate-buffered saline (PBS), urine, saliva, etc.). Typically, in this class of transient electronic devices water-soluble organic electronic materials are used along with water-soluble metals such as Mg and Zn to form electronic components and conductive paths of the circuit. Less common is use of very small amounts of innately insoluble materials such as silicon, which dissolves at a notably slow rate.

Polymer-based and natural water-soluble substrates with programmable transiency rate, lasting from minutes to months, have been investigated and reported. In recent investigations, thin-films made from silk, poly(L-lactide-co-glycolide) (PLGA), poly(dimethylsiloxane) (PDMS), polylactic acid (PLA), polycaprolactone (PCL), poly(glycerol-co-sebacate) (PGS), poly(vinyl alcohol) (PVA), and nanofibrous polymeric membranes were investigated as substrates of transient electronic devices. In some studies membranes were investigated separately and in others loaded with electric circuits. Electronic components are typically fabricated on the substrates by a wide range of fabrication techniques, including physical vapor deposition, electron beam evaporation, photolithography, surface modification, stencil mask printing and/or etching of thin-films of bulk materials.

Transiency mechanisms in electronic components are investigated both analytically and experimentally. Depending on materials and stimuli, transiency of electronic components occurs through corrosion, dissolution, hydrolysis or a combination of these processes. It is typically quantified by means of mass loss or change in the thickness of the component. Since these processes all depend on penetration of water or hydroxide ions into the structure through the thickness, the dissolution time and rate are determined by reaction constants, diffusivities of the materials, the thickness of the films, and other parameters of materials and solutions such as material morphology, pH, temperature, concentration of liquid media etc. Unlike polymeric substrates that typically have fast transiency rates, transiency of metallic thin-films, even for very small thicknesses, when deposited from bulk is very slow and very often a limiting factor to transiency of the system as a whole. Ideally, a system in which substrate and electronic components have the same or similar transiency rates is advantageous and desired.

### SUMMARY OF THE INVENTION

The present invention provides in one embodiment a transient electronic device comprising a transient substrate having an electronic component constructed thereon, wherein the electronic component comprises colloidal metallic particles that are initially deposited from a colloidal dispersion on the substrate to construct the electronic component on the substrate and that are subsequently re-dispersible in a solvent-containing medium to deconstruct the electronic component of the electronic device. Typically, the substrate and the electronic component are triggered to concurrently deconstruct in the solvent-containing medium.

In an illustrative embodiment of the present invention, one or more electronic components of a transient electronic circuit is/are formed by deposition of the colloidal metallic particles as a conductive thin film, rather than as bulk materials, on the substrate.

In another illustrative embodiment of the present invention, the transient substrate comprises a soluble polymer, such as a water-soluble polymer that is modified with a transiency-controlling agent.

In another illustrative embodiment of the present invention, the colloidal metallic particles comprise an insoluble metal or alloy such as, for example, a noble metal or copper.

A transient lithium ion battery is provided pursuant to other embodiments of the present invention.

The present invention envisions a method wherein a transient electronic device is deconstructed by re-dispersion of the electronic component material by contact with a solvent-containing medium, such as water, water-containing solvent, bodily fluid and the like.

In practicing embodiments of the present invention, the force generated by swelling of the substrate (swelling force) is utilized to enhance physical deconstruction and transiency of the electronic components; and, as a control factor for programming the transiency rate. In such transient electronic devices, transiency can be programed by means of dissolution characteristics of substrate and concomitant re-dispersion of colloidal-based metallic circuit component(s).

### DESCRIPTION OF THE DRAWINGS

FIG. 1 is a schematic illustration for decontruction of transient electronics over time based on the dissolution mechanism of polymer membranes where in the Top Row of FIG. 1 the Complete dissolution of polymer matrix is shown where in Stage 1 a polymer film is shown, in Stage 2 swelling is shown, in Stage 3 complete dissolution is shown; and where in the Bottom Row the Complete dissolution of transient device is shown where in Stage 1 the device is shown as an electrical circuit superimposed on a substrate and its polymer chains, in Stage 2 the circuit is shown to prevent movement of substrate polymer chains connected to the circuit, in Stage 3 further expansion of substrate and disconnection of circuit is shown, and in Stage 4 complete dissolution of substrate polymer chains and breaking of circuit to individual colloidal particles is shown.

FIG. 2 shows plots a and b depicting viscosity measurements for PVA polymer matrix substrate (plot a), and the transient device (plot b) over the period of time demonstrating their dissolution. Viscosity was given as reduced viscosity to normalize the measurements with respect to the concentration of a sample. Note that the plot is semi-log. PVA/sucrose polymer matrix with the ratio of 1:2 was used. The Inset c shown within FIG. 2 shows the typical transient device where the right half of the device shown in the inset was used for viscosity measurements.

FIGS. 3a, 3b, and 3c depict the effect of sucrose content of polymer matrix substrate on the critical parameters of dissolution obtained from viscosity measurements for substrates (dotted lines) and devices (solid lines). FIG. 3a shows “t_{bp}” which is the break point time for system transiency, FIG. 3b shows “η₀” which is the initial reduced viscosity and FIG. 3c shows “TN” which is the reduced break point viscosity.

FIG. 4 shows a ATR-FTIR spectra of PVA-sucrose substrates with varying composition. The bands at 1142 cm⁻¹ are the indication of the semi-crystalline PVA.

FIGS. 5a, 5b, and 5c depict swelling of transient devices with PVA/sucrose matrix substrates. FIG. 5a shows swelling with a PVA: sucrose weight ratio of 1:0, FIG. 5b shows swelling with a PVA: sucrose ratio of 2:1, and FIG. 5b shows swelling with a PVA: sucrose ratio of 1:1. Background is a 5 mm grid. Time passed after immersion of transient devices in water is given at the right bottom corner of the images.

FIG. 6a shows a comparison of the pace of expansion for the blank and the circuit parts of devices in the first minute of an experiment. FIG. 6b shows a comparison of the maximum expansion achieved over the time period of experiments. The second axis shows the time at which maximum expansion is observed indicating the pace of expansion.

FIG. 7a shows hydration of PVA which results in swelling of the polymer membrane, PVA repeat unit is identified on the top left of the figure; FIG. 7b shows half reactions that take place at the electrodes; FIG. 7c shows swelling and FIG. 7d shows curling of electrodes with high area density layers of active materials after 3 minutes of exposure to water; despite fragmentation of the active materials, deconstruction and transiency did not occur; FIG. 7e depicts sequential images of transience of a cathode electrode with low area density layer of active materials, where the swelling force is large enough to deconstruct the electrode; and FIG. 7f depicts dissolution of soluble and re-dispersion of insoluble constituent materials that leads to full transiency, where the small arrow in FIG. 7f points at a scale bar drawn in the background. Note that scale-bar on FIG. 7f is different.

FIG. 8a is a schematic representation of the cross section of the battery cell where the different elements of the battery cell are represented by the different cross-sections shown to the right in the figure; FIG. 8b shows an image of a transient battery cell; and FIG. 8c shows sequential images of transience of a battery cell, where the small arrows point at scale bars drawn in the background. Note that scale-bars on the last two images are different.

FIGS. 9a and 9b show the discharging behavior of transient battery cells at different current densities. FIGS. 9c and 9d show electrochemical impedance of a battery cell over frequency ranges and the equivalent electrical circuit that is shown as the inset within FIG. 9c.

### DETAILED DESCRIPTION OF THE INVENTION

The present invention is described below for purposes of illustration with respect to a transient electronic device that comprises a transient substrate having an electronic component constructed thereon. The transient substrate can comprise a soluble polymer, such as a water soluble polymer, or any other material that is soluble or destructible over time in a solvent-containing medium to be encountered. The substrate material may be optionally modified by inclusion of a transiency-controlling agent that affects the transiency period of deconstruction of the substrate. For purposes of illustration and not limitation, the substrate can comprise polyvinyl alcohol (PVA) unmodified, or modified by inclusion of sucrose or other transiency-controlling agent.

The electronic component can comprise a resistor, capacitor, inductor, conductor path, and any other component of an electronic circuit. The electronic component comprises colloidal metallic particles that are initially deposited as a conductive thin film from a colloidal dispersion on the substrate to construct the electronic component on the substrate and that is subsequently re-dispersible in the solvent-containing medium to deconstruct the electronic component of the electronic device. For purposes of illustration and not limitation, the colloidal metallic particles comprise an insoluble metal or alloy such as, for example, a noble metal or copper in an initial aqueous dispersion.

Typically, the substrate and the electronic component are triggered to concurrently deconstruct in the solvent-containing medium by selection of suitable substrate and electronic materials in dependence upon the solvent-containing medium to be encountered. The solvent-containing medium can comprise water, water-containing solvent, bodily fluid (e.g. saline, saliva, urine, etc.) and any other medium to be encountered in service of the transient electronic device.

The following Examples are offered to illustrate the present invention in more detail without limiting the scope of the invention in any way.

### EXAMPLE 1

This Example demonstrates fabrication of conductive electronic components of a transient electronic device utilizing deposited and re-dispersible colloidal metal particles to achieve fast and coordinated deconstruction and transiency of polymeric substrate and electronic components in transient electronic devices. This Example demonstrates realization of controlled transiency by eliminating limiting factors posed by slow dissolution rate of metals and demonstrates that, if colloidal metal particles are used for conductive paths, the transiency of polymer-based substrates, which is easier to control, can be used to program transiency of the whole system, unlike conventional transient electronics.

Experimental

Preparation of Substrates:

Poly(vinyl alcohol) (PVA) (Mowiol 10-98, MW: 61,000 g mol′, 98.0-98.8 mol% hydrolysis) and sucrose were purchased from the Sigma Aldrich and used as received. To prepare polymer membranes with different PVA:sucrose ratio, desired amount of sucrose was dissolved in 20 ml, deionized water (resistivity≧18.0 MΩ-cm) at room temperature. PVA and 50 μL of I M aqueous HCI solution was added to the solution. The solution was magnetically stirred at 70° C. for 4 hours to allow complete dissolution of PVA, then cooled to room temperature and casted on 86 mm×128 mm flat polymer molds. Polymer films were carefully peeled off when dried; drying time varied from 24 to 48 hours depending on the sucrose concentration and film thickness. For 1 g total substrate, the films thickness was 70±10 gm. Films with PVA:sucrose ratios of 1:0, 10:1, 2:1, 1; 1, 1:2) were fabricated.

Fabrication of Circuits:

Conductive silver paste (Pelco, 187 Series) was purchased from Ted Pella Inc. and diluted with acetone at 1:1 ratio. Vinyl masks with desired circuit design were fabricated using a vinyl cutter (US-Cutter. SC series) with 25 micron resolution and 125 micron repetition accuracy. Conductive silver paths were produced by spray coating of diluted silver over the vinyl mask. An average circuit consisted of 20 mm wide conductive paths and covered an area of 1.25 cm 2 on the substrate. The net amount of silver (dried) used to cover this area was 2.8±0.2 mg (corresponding thickness is about 13 μm).

Rheology Measurements:

Viscosity of the substrates and devices was measured by a rheometer (AR2000ex, TA Instruments) with a cone and plate geometry (steel 4° cone angle and 40 mm diameter). Specimen was placed in 1.17 mL of DI water at center of the plate. A solvent trap was used to prevent water evaporation during measurements. Viscosity of the sample was measured and recorded every 10 seconds at the constant shear rate of 1 s⁻¹ at 25.0±0.1° C.

The recorded viscosity values were normalized with respect to the solvent viscosity (pure water); the concentration of the solution vs. the reduced viscosity, η_{red}, were then plotted. Reduced viscosity was deduced from the viscosity of solution (η), solvent (ηₒ) and concentration (c), using Equation 2.

η_{red}=(η/ηₒ−1)/c (2)

The data was shifted on the horizontal axis to correct for the few second time lag between immersing the sample in the solvent and starting the analysis.

At the applied shear rate of 1 s⁻¹, the data was fluctuating at every 90 seconds indicating the inhomogeneity of the solution during dissolution event, then moving average of 9 was employed to smooth the data.

Swelling Measurements:

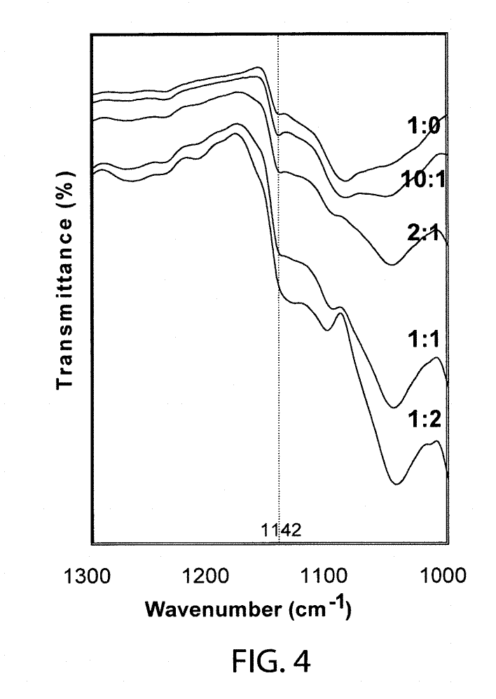

Swelling of a polymeric substrates in solvent was quantified by measuring the changes in planar dimensions of the specimens (blank of circuit parts of the device) as a function of time. Specimens were labeled with marks of known geometry and dimensions (FIGS. 4a-4c as an example). A charged couple device (Canon EOS Rebel SLI I OOD) was used to obtain sequential images of specimens against a gridded background at desired time intervals to monitor and record position of the labels and determine swelling rate and behavior. Image-J software was used for image analysis. At least three readings were taken for each measurement and averages were reported.

Infrared Spectroscopy:

Attenuated total reflectance-Fourier transform infrared (ATR-FTIR) spectroscopy (Frontier Perkin Elmer) equipped with single reflection ATR attachment with diamond crystal was used for this study. Samples were placed directly on the ATR crystal. Four scans with a spectral resolution of 4 cm⁻¹ were taken at room temperature for each sample. Data was processed by Spectrum 10 software. For each spectrum, an interactive baseline correction with respect to the position of 4000 cm⁻¹ was employed.

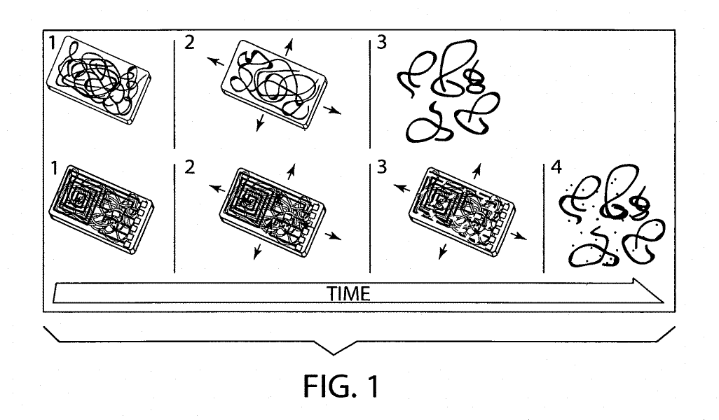

As a first step, the dissolution behaviors of the substrate and device were scrutinized. Dissolution behavior of polymers is influenced by the solvent-monomer and monomer-monomer interactions. For transiency to occur, solvent-monomer interactions should dominate over monomer-monomer interactions allowing the solvent to penetrate into the polymer matrix and cause the matrix to swell. For thermoplastics, such as PVA used in this Example, during swelling polymer chains disentangle and diffuse out from the matrix. Solution of single polymer chains obtained at the end defines the complete dissolution (FIG. 1, top row). Expansion of the membrane while swelling appears to apply a mechanical force on the circuit, which results in its physical disintegration, although the inventors do not intend or wish to be bound by any theory in this regard. As illustrated in FIG. 1, bottom row, initially (stages 1 and 2), expansion force may not be enough to disintegrate the circuit as integrity of the circuit prevents movement of the polymer chains that are in contact with the circuit, and leads to a resistance to expansion. As the tendency to expansion (swelling force) reaches a critical point, the circuit starts to disintegrate (stage 3). Finally, polymer matrix is completely dissolved; and, due to lack of a mechanical support from the substrate platform, individual colloidal particles forming the circuit are dispersed in the solution (stage 4). The possible mechanism is tested by means of rheological behavior of dissolution and the swelling behavior of the substrate and the device.

The rheological properties of polymer solutions are influenced by the polymer structure. Thus, viscosity measurements could be utilized to assess the extent of transiency of the polymer membrane. Shear stress (τ) and viscosity of a polymer solution (η) are directly proportional as presented in Equation 1.

τ=η×γ (1)

where γ is the shear rate applied; thus, viscosity measurements conducted at constant shear rate can be used to interpret the strength of chemical interactions in liquid media.

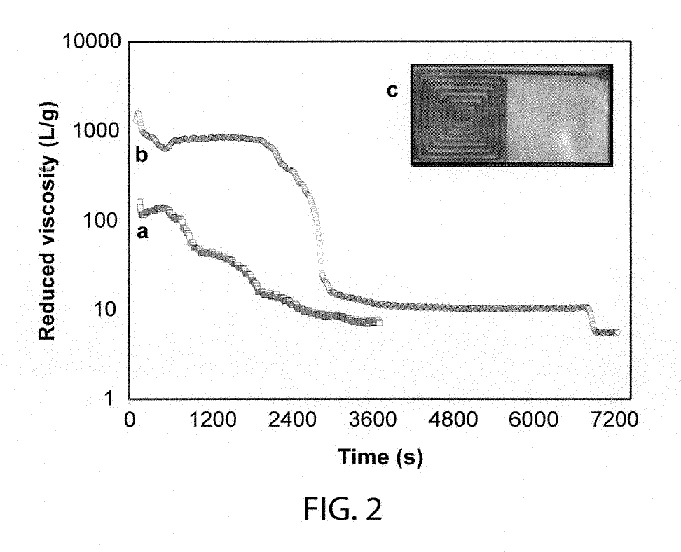

FIG. 2 demonstrates the viscosity measurements taken immediately after exposure to water for substrates and devices. As water is penetrating through the polymer matrix, chemical interactions among polymer chains are weaken and swelling occurs, expansion in polymer structure leads to disentanglement of some polymer chains; which, in turn, results in a decrease in the viscosity. As demonstrated in FIG. 2 (graph a), for a bare polymer substrate an overall gradual decrease of viscosity was observed upon exposure to the solvent; and, continued until a stable plateau was reached. Fabrication of an electric circuit on polymer substrate proved to limit mobility of polymer chains against each other when exposed to the solvent; and, delays the overall swelling process. Contrary to bare polymer substrates, those containing a circuit exhibited a two-stage plateau (FIG. 2-graph b), the first implying the resistance of the system to swelling at relatively high viscosity followed by a second plateau at approximately the same viscosity of that of a bare substrate indicating re-dispersion and dissolution of the whole system (circuit and substrate). The time separating the two plateaus is the time required for enough amount of solvent to penetrate into the matrix to generate a swelling force large enough to dominated over compression stress due to the presence of circuit; at this point the circuit is disconnected and a steep reduction in viscosity is measured (stage 3 in bottom row of FIG. 1), referred to as break-point (bp) for system transiency. The second equilibrium state is an intermediate step where the shape of the circuit is partially preserved although the colloidal particles are disconnected. In the third and last equilibrium state, viscosity approached to the equilibrium indicating a stable partially or fully dissolved state (stage 4 in bottom row of FIG. 1). Absence of a platform to hold individual colloidal particles leads to complete disintegration of the circuit and re-dispersion of constituent colloidal particles.

The break-point time (t_{bp}), the initial reduced viscosity (η₀) and the reduced break-point viscosity (η_{bp}), can be determined as the critical parameters of dissolution obtained from viscosity measurements in order to investigate the effect of dissolution behavior of substrates and transient devices.

Vanishing behavior (deconstruction) of transient substrates and electronics:

Rheological Behavior:

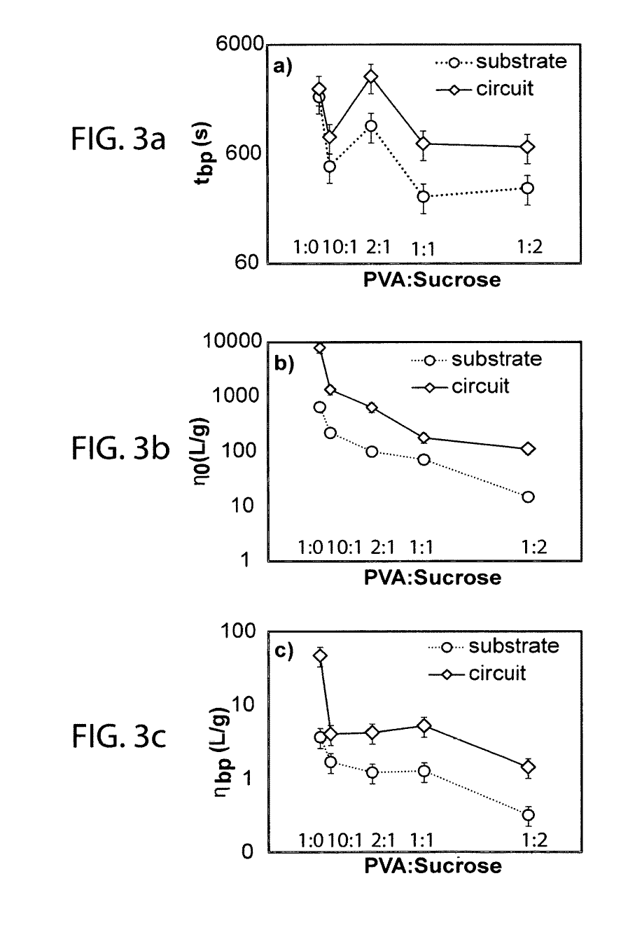

The critical parameters of dissolution are compared for varying concentration of the PVA/sucrose substrates and reported in FIGS. 3a-3c. FIG. 3a shows that sucrose dominating substrates, the substrates with sucrose concentration of equal to or higher than that of PVA, manifest faster dissolution than others. Similar behavior was observed by measuring the weight loss of substrates as a function of time. Comparing to weight loss measurements, viscosity measurements are expected to result in relatively longer dissolution times since the available water content for dissolution is limited (the volume of cone and plate geometry is about 1.2 mL, regarding concentration of the samples are around 13-17 g/L).

Faster dissolution and lower viscosities of sucrose containing PVA substrates could be explained by chemical interactions within substrate and between substrate and the solvent. The FTIR spectra in FIG. 4 focuses on the band at 1141 cm⁻¹ corresponding to the symmetric C—C stretching mode and shows pronounced absorption with increased sucrose concentration indicating the more crystalline polymer substrates. The dissolution rate of the PVA polymer films is proportional to the degree of crystallinity; thus, fast dissolution of sucrose dominating PVA substrates is attributed to their increasing crystallinity. With increasing sucrose concentration, more sucrose interact with higher portion of PVA chains create more volume of crystalline domains while intuitively disentangling the polymer chains. Combined with very fast dissolution of sucrose domains in water, less entangled matrix leads to faster dissolution and lower viscosities as observed in FIGS. 3a-3c.

As shown in FIG. 2b and FIG. 3a, the presence of the electronic circuit restricts the movements of polymer chains and delay its dissolution and expansion. Swelling behavior in the absence and presence of circuit is discussed in more detail below.

As the polymer matrix is first exposed to water, the measured viscosity can be considered as an analogous to the Young modulus, as the measured value is the shear stress in the case of viscosity measurements rather than the tensile stress as in tensile measurements. In order to calculate the reduced viscosity, the increment in viscosity with respect to pure water solvent is calculated and normalized to the substrate concentration in water. The Young modulus values, which have been reported for the PVA/sucrose composites, trends in the same way with the initial reduced viscosity reported in FIG. 3b, which partly confirms the validity of using viscosity measurements to investigate the dissolution behavior. Having the electronic circuit on top of the substrate resulted in higher viscosity, i.e. exhibits higher resistance to flow, comparing to the measurements for substrates with the same composition.

Sucrose acted as a plasticizer for PVA and decreased the dissolved reduced viscosity of solutions from 3.7 L/g to 0.3 L/g (FIG. 3c). Particles or broken pieces of circuits in solution act as obstacles to flow of solution and lead to higher reduced break-point viscosity values (FIG. 3c).

Rheological measurements can be used as a tool for investigation the dissolution behavior of transient devices since it explains the full in situ dissolution behavior of not only substrates but also devices. Examples of its further use include mimicking the real application conditions of transiency in a sample such as in solvents with varying pH, temperature and chemistry. The critical parameters of application in interest such as the maximum shear stress, dissolution behavior under shear, etc. could also be investigated by means of the rheological behavior, which is challenging via the weight loss measurements. Viscosity measurements at constant shear rate offer comprehensive information about not only in situ behavior of substrates, but also that of devices as a whole, such as dissolution, degradation and/or transiency behavior, viscoelastic behavior, and programmability.

Swelling Behavior:

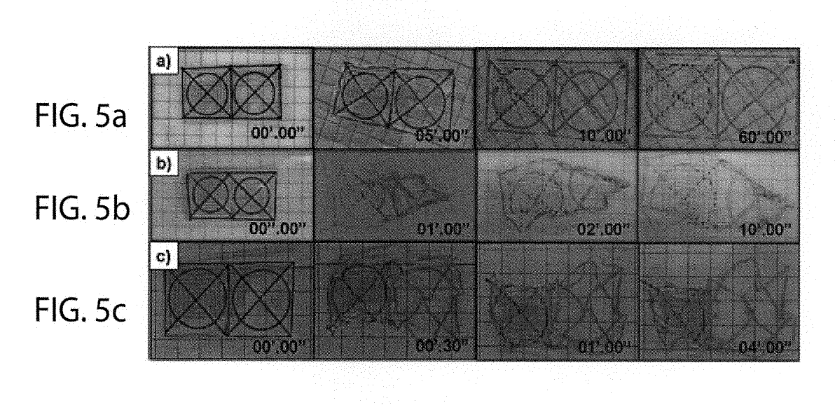

Function of a transient device is directly related with integrity of the electronic circuit on the substrate. Since disconnection and/or breaking of the electronic circuit can be controlled by swelling a polymer composite substrate film, expansion of the substrates and devices was investigated. FIGS. 5a-5c demonstrate the distinct behavior of devices controlled only by changing the composition of the substrate by inclusion of a transiency-controlling agent, such as sucrose. Among all, the device with pure PVA substrate showed the slowest expansion, FIG. 5a, while the device with 2:1 PVA:sucrose weight ratio (FIG. 5b) exhibited the largest expansion. Independent from the duration of expansion, in both case, expansion forces lead to breaking of the circuit into almost individual particles. As the concentration increased further (to 1:1 PVA:sucrose weight ratio, FIG. 5c), however, the transiency of substrate was too fast, thus the substrate dissolved even before breaking the circuit, left it almost complete.

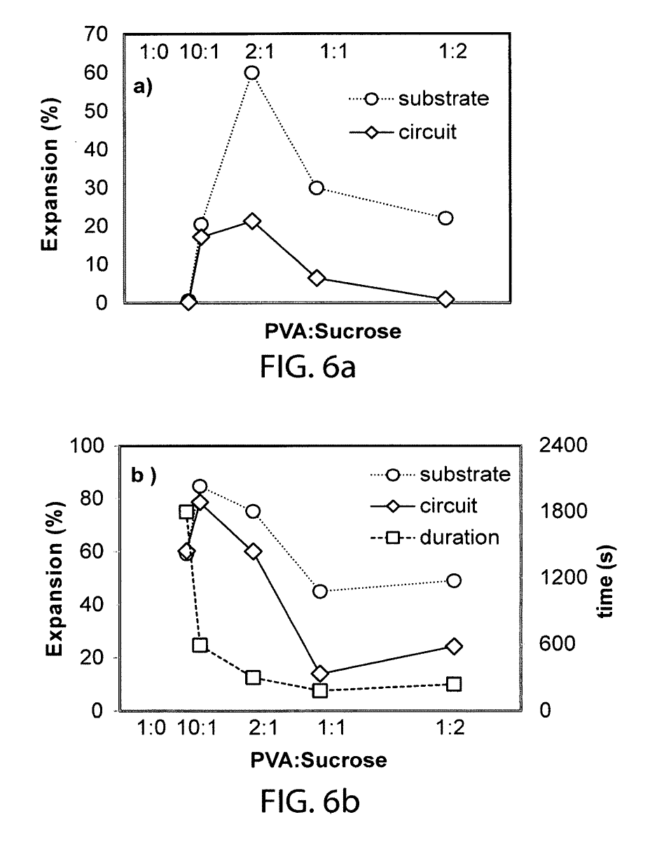

FIG. 6a compares the pace of expansion for the blank and the circuit parts of devices in the first minute of an experiment. The maximum expansion of the device achieved during experiments and the time passed to reach this level of expansion are plotted in FIG. 6b. Fom the viscosity measurements reported above, the interactions of PVA polymer chains in pure PVA substrate are relatively much stronger (deduced by the higher viscosity values) and its dissolution is much slower than that of its sucrose containing composites (deduced by the higher dissolution times). During swelling experiments, expansion of pure PVA substrates reached to the values as high as 60% in 60 min without a significant difference between blank and circuit parts of the device (the difference is about 10% at its maximum) indicating that the interactions between polymer chains is strong enough to disconnect the circuits as the film expands. Since polymer film dissolved slowly, the shape of the circuit could be preserved even after an hour of exposure to a stimuli, but in the form of almost individual particles.

With a small addition of sucrose to the PVA (10:1), the largest expansion, around 85% for the blank and 80%, for the circuit parts of a device, could be obtained: in 10 min of exposure. Strong chemical interactions (hydrogen bonding capability) of sucrose with both PVA and water might attract the water molecules towards into the polymer matrix and result in larger expansion as compared to that of pure PVA sample. As observed in FIG. 5b, the fast expansion resulted in disconnection of the circuit very fast.

The samples of substrates with the composition of 2:1 exhibits the fastest expansion among other samples. The blank and circuit part of the device for this composition expands about 75% and 60%, respectively only in 5 minutes exposure to stimuli. The expansion difference between blank and circuit parts was decreased from 40% to 20% in the first minute of exposure indicating that the circuit could not resist to this significant expansion and disconnected in only few minutes after being exposed to the stimuli.

Increasing the concentration of sucrose to equal or higher concentrations than that of PVA (1:1 and 1:2), resulted in very fast dissolution of substrates. As discussed above, the relatively less entanglements in sucrose dominating substrates limit the expansion of the composite matrix. Substrates with high sucrose concentration (1:1, 1:2) could expand to a limited level of 45% while the maximum expansion of circuit parts was about 20%. Because of the absence of strong expansion forces, the interactions which hold silver particles of the circuit together dominates, and the circuit could preserve its integrity even though the substrates dissolved away.

The mechanical properties of these devices could also be programmed by adjusting the thickness of a substrate. Thinner substrates are expected to dissolve more quickly than thicker samples. Fracture of a circuit due to the bending of a flexible substrate could be prevented by using thicker substrates or by optimizing the mechanical, chemical and transiency properties of a substrate or in the presence of external support such as tissue or skin.

The fact that the integrity of circuit could be controlled by dissolution behavior of the substrate as discussed in FIG. 5a-5c, the same simple system can be used for a range of applications by felicitous choice of substrate chemistry that tunes the chemistry and physical properties of the devices. Slowly degrading substrates (1:0 and 10:1) can be used for biological application which requires programmable degradation, while instant degradation as in the sample of 2:1 can be used for military applications. The samples which the circuit could preserve its integrity despite of the degradation of substrate (1:1, 1:2) can be used for making sensors applied on surfaces of human skin, plants, etc. for more accurate and precise measurements. After placing the sample on the surface, substrate could be washed off. The remaining functional parts of the device would directly interact with the surface of a target and will potentially enhance quality of a contact.

The Example above demonstrates the approach of the invention toward fabrication of conductive components of transient electronics utilizing colloidal metal particles to achieve fast and coordinated deconstruction and transiency of polymeric substrate and electronic components in transient electronic devices. A transformative and appealing aspect of this approach is that it allows realization of controlled transiency by eliminating limiting factors posed by slow dissolution rate of metals. It was demonstrated that if colloidal metal particles are used for conductive paths, the transiency of polymer-based substrates, which are easier to control, can be used to program transiency of the whole system; and, that unlike conventional transient electronics, transiency rate of substrate can be a controlling and dominating factor.

The following additional Example is offered to illustrate a transient lithium-ion battery pursuant to an embodiment of the present invention without limiting the present invention in any way.

### EXAMPLE 2

As mentioned above, in the very recent years, researchers have developed a wide range of transient electronic devices capable of performing a variety of functions and responsive to a variety of triggering mechanisms including exposure to light, heat or solvent (often aqueous). What is common among all these reported transient devices is the need for an external power source. The power is either supplied by inducting coils from a very close distance, or from external power supplies. To realize autonomous transient electronic devices, similar to conventional ones, a transient battery is essential. Thus far, there has been limited efforts in design and construction of transient batteries, mainly due to the lack of soluble proper materials. Jimbo et al. in Sensors and Actuators B; Chemical 2008, 134, 219-224, reported swallowable batteries based on Zn and Pt electrodes and ceramic porous separator; maximum potential of 0.42 V and current of 2.41 mA were achieved. More recently Kim et al. in J. Proceedings of the National Academy of Sciences, 2013, 110, 20912-20917, reported edible water activated sodium batteries based on melanin electrodes where a potential of 0.6-1.06 V and current of 5-20 μA, depending on design, was achieved. An intrinsically transient battery capable of environmental resorption was first reported by Yin et al. in Advanced Functional Materials, 2014, 24, 645-658, where Mg anode and biodegradable metals (Fe, W or Mo) cathodes were used with a transient polymer casing; potentials ranging from 0.45 V to 0.75 V (depending on cathode materials) were reported. To date, all reported transient batteries have shortcomings compare to their conventional counterparts; uncompetitive potential, current, stability and shelf life are among the top challenges in construction of a practical transient battery that can supply enough power to run a common electric circuit. The low potential and power density in transient batteries are mainly due to the use of non-optimal electrode materials because of their solubility. One other significantly important limitations of transient batteries reported to-date is low transiency rate, which is a result of slow chemical reactions between the constituent materials and the solvent. High transiency rates are specially anticipated in military and hardware security applications.

Lithium-ion battery technology is a well-established, mature and commercialized technology. An embodiment of the invention integrates a transient electronics approach to battery construction/deconstruction, which is ultimately based on a hybrid approach of physical redispersion of insoluble materials, and chemical dissolution of soluble ones.

This Example demonstrates a transient primary Li-ion battery that consists of electrodes comprising active materials similar to those in conventional Li-ion batteries, while swelling force of the transient substrate/casing materials is utilized to introduce transiency through fragmentation and redispersion of the active electronic component materials.

This Example describes a transient Li-ion battery based on polymeric constituents having double the potential reported in the literature for transient batteries. The battery takes advantage of active materials used in conventional Li-ion batteries and can achieve and maintain a potential of >2.5 V. All materials are deposited form polymer-based emulsions and the transiency is achieved through redispersion of insoluble, and dissolution of soluble components in approximately 30 minutes.

Experimental Section

Materials: Polyvinyl alcohol (PVA) (Mw: 61,000 g mol⁻¹, 98.0-98.8% hydrolyzed), sucrose, lithium hexafluorophosphate (LiPF₆), ethylene carbonate (EC) and dimethyl carbonate (DMC) were purchased form Sigma Aldrich (Sigma Aldrich, Mo., USA) and used as received. LiCoO₂, (LCO) powder, Li₄Ti₅O₁₂ (LTO) powder and carbon black were purchased from MTI (MTI Corporation, CA, USA) and used as received. Commercially available short fiber cellulose based tissue was used as separator. Silver paint was purchased from Ted Pella (Ted Pella, Inc. CA, USA) and diluted with acetone (1:1 vol).

Substrate: 1.0 g PVA, 0.1 g sucrose, and 50 μL of 1 M aqueous HCl solution were added to 20 mL of DI water. The solution was stirred at 70° C. for 4 hours, then cooled down to room temperature and stirred for 2 additional hours. The clear solution was then cast onto a plastic mold (with14 mm×1.2 mm×0.1 mm grooves for current leads) and dried at ambient conditions for 24 hours. The dried PVA film was peeled off of the mold carefully and used as the substrate on which the cathode and anode were deposited.

Active Materials: To prepare cathode active material 1.0 g PVA was dissolved in 20 mL DI water and stirred at 70° C. for 4 hours. 5.15 g LCO powder and 1.0 g carbon black were added to the PVA solution and stirred for 2 hours to get uniform emulsion. Anode active material was prepared in the same manner with the exact same ratios and procedure as cathode, where LCO was substitute by LTO.

Current leads: 1 g PVA was dissolved in 20 mL DI water as described above, carbon black was added at 3:2 wt. ratio (3 carbon black) and stirred for 2 hours to obtain a uniform emulsion. Silver paint was diluted with acetone (1:1 vol. ratio). Current lead at anode was fabricated by spraying 60 μm thick layer of silver in the groove of PVA substrate; then, an approximately 50 μm thick layer of carbon black-PVA emulsion was spray coated on top of the silver layer at slightly wider (about 500 μm) area to cover the silver coating. Stencils were used at both steps. Current lead at cathode was fabricated by spraying a 110 μm thick layer of carbon black-PVA emulsion through a stencil in the groove of PVA substrate.

Electrodes: about 25 μm thick layers of anode and cathode active materials were spray coated through stencils over the current leads on PVA substrates to form the electrodes. The areas covered by active materials were smaller than the substrate area to allow PVA edge for packing.

Packaging: Cathode, anode and cellulose-based porous membrane were brought together to form a stack. Uncoated edges of PVA substrates were dampened slightly to bond and seal the stack to form a battery cell.

Electrolyte: 1 M solution of LiPF₆ in 1:1 mixture of EC:DMC was used as the electrolyte. Electrolyte (25 μL) was injected into the packed battery cell by a syringe and pierced area was sealed. All steps involving electrolyte were carried out in a glovebox under nitrogen environment.

Electrochemical testing: The electrochemical testing and impedance measurements were carried out on a VersaSTAT-4 potentiostat (Princeton Applied Research). The battery was charged and discharged at 2.7 V and 1.0 V, respectively, and discharge current densities of 10, 20 and 50 μA·cm⁻². The internal resistance of the battery cell was measured at frequencies between 1.0E5 Hz and 0.1 Hz and a potential difference (ΔV) of 10 mV. The Z-view software was used to obtain the equivalent electric circuit and fit experimental data.

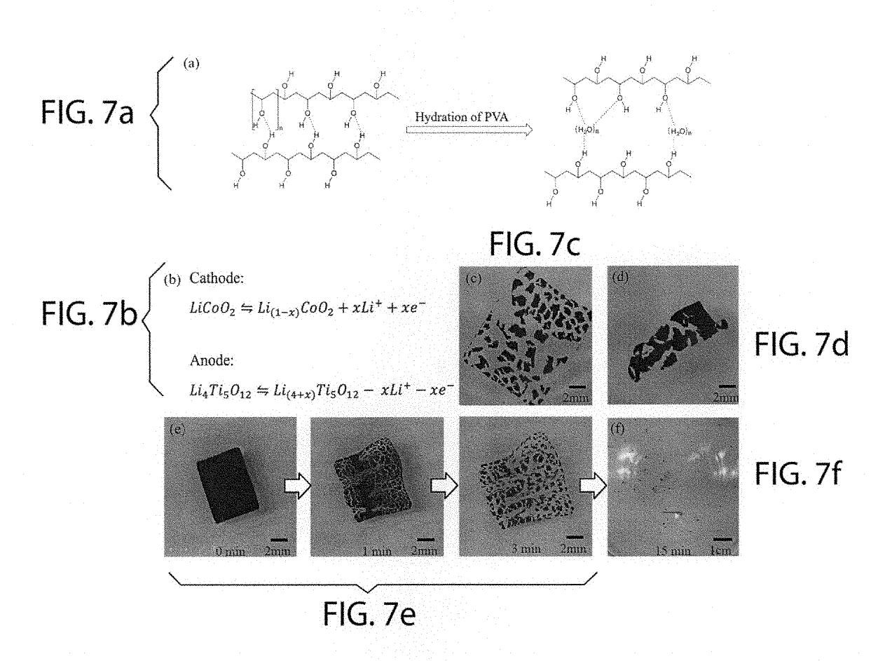

Due to its ease of control over transiency rate and fabrication, PVA and PVA composites were used as binder, substrate and casing materials. Abundance of hydroxyl groups in PVA allows high equilibrium swelling indices, up to 153% in water. Hydration of PVA results in disentanglement of polymer chains and leads to swelling of the polymer membrane, FIG. 7a. In PVA-sucrose composites, presence of fast-dissolving sucrose expedites the process by opening up voids in the structure that enhance penetration of water. Subsequently, PVA chains are eventually solvated and the membrane dissolves in the solvent. Lithium cobalt oxide, LiCoO₂, (LCO) and Li₄Ti₅O₁₂ (LTO) were used as the ultimate cathode and anode active materials, respectively. Cathode and anode half reactions are shown in FIG. 7b. PVA and carbon black were used as binder and filler in LCO and LTO to form water-deconstructible nanostructures. Presence of PVA and carbon black in LCO and LTO increases uniformity of the electrodes while also enhancing redispersion of the materials when triggered. On the other hand, efficiency of the electrodes drops due to the lack of electron conductivity in PVA. Active materials (LCO/LTO-PVA-carbon black aqueous emulsion) were deposited via spray coating over a stencil mask. Systematic studies of electrode components revealed that the thickness of active materials coating is the defining factor on whether or not the electrode fully disintegrates, where no dependence on the thickness of the PVA-sucrose substrate was observed. Cathode electrodes with active materials area densities ranging from 1 mg·cm⁻² to 2.5 mg·cm² (categorized in three groups: 1) 1.2±0.1, 2) 1.6±0.1 and 3) 2.3±0.2 mg·cm⁻²) were fabricated on PVA:sucrose (10:1 weight ratio) substrates of thicknesses ranging from 30 μm to 80 μm (categorized in six groups, 10 μm increments). PVA at this particular composition was selected for its fast and controllable transience rate. Regardless of the thickness of substrate, when exposed to the solvent, electrodes with active materials' area densities of 1.5 mg·cm⁻² or higher only curled and/or swelled but did not disintegrate nor exhibit transiency, FIGS. 7c and 7d. For active materials area densities of 1.3 mg·cm² or lower (group 1), the electrodes swelled and the swelling force was large enough to fragment and deconstruct the whole electrode, regardless of the thickness of the substrate. Fragment average area (average size of fragments due to crack propagation) was smaller for electrodes with smaller active materials area density, see Table 1 and FIGS. 7c-7f. As the solvent molecules penetrate through the substrate, swelling force is generated and increased to a point large enough to physically break the active materials layer, FIG. 7e. Swelling of PVA and the associated force which breaks the active materials into pieces are essential to the transiency of the electrode; an identical sample of active materials (same area density) on polyvinyl acetate substrate (does not swell but dissolve in water) only curled and did not break or exhibit transiency. After initial swelling, the substrate is eventually dissolved and resorbed into the aqueous environment; subsequently, PVA binder in the remaining pieces of the active materials also dissolves which enhances redispersion and transiency of the active materials in the solvent (FIG. 7f). Summarized in Table 1 are the experimental data collected and outcomes for variety of cathodes structures. Results revealed that electrodes with small area density are essential for construction of a transient battery. Similar study on anodes resulted in comparable conclusions.

TABLE 1
Transiency test on samples with varying
area density of the active materials

| | Area Density of Active Materials (mg · cm⁻²): | | |
|---|---|---|---|
| | 1.2 ± 0.1 | 1.6 ± 0.1 | 2.3 ± 0.2 |
| Fragment Average Area | ~0.77 mm² | ~1.82 mm² | ~4.4 mm² |
| Electrode-Substrate | Yes | No | No |
| Delamination | | | |
| Outcome | Transiency | Sample curled | Sample curled |

FIG. 7a shows hydration of PVA which results in swelling of the polymer membrane, PVA repeat unit is identified on the top left of the figure; FIG. 7b shows half reactions take place at the electrodes; FIG. 7c depicts swelling and FIG. 7d shows curling of electrodes with high area density layers of active materials after 3 minutes of exposure to water; despite fragmentation of the active materials, deconstruction and transiency did not occur; FIG. 7e provides sequential images of transience of a cathode electrode with low area density layer of active materials, the swelling force is large enough to deconstruct the electrode; FIG. 7f shows dissolution of soluble and re-dispersion of insoluble constituent materials leads to full transiency, the arrow points at a scale bar drawn in the background. Note that scale-bar on FIG. 7f is different.

Single cell batteries were constructed by fabrication of current leads and active materials on PVA-based substrates. The substrates were featured with grooves to hold current leads.

A cellulose-based porous membrane (short fibers thus water decomposable) was used as the separator and electrolyte holder between the electrodes; and, battery was formed and sealed by attaching the uncoated margins of the PVA-based electrodes together. LiPF₆-based electrolyte was then injected into the separator and the hole was sealed.

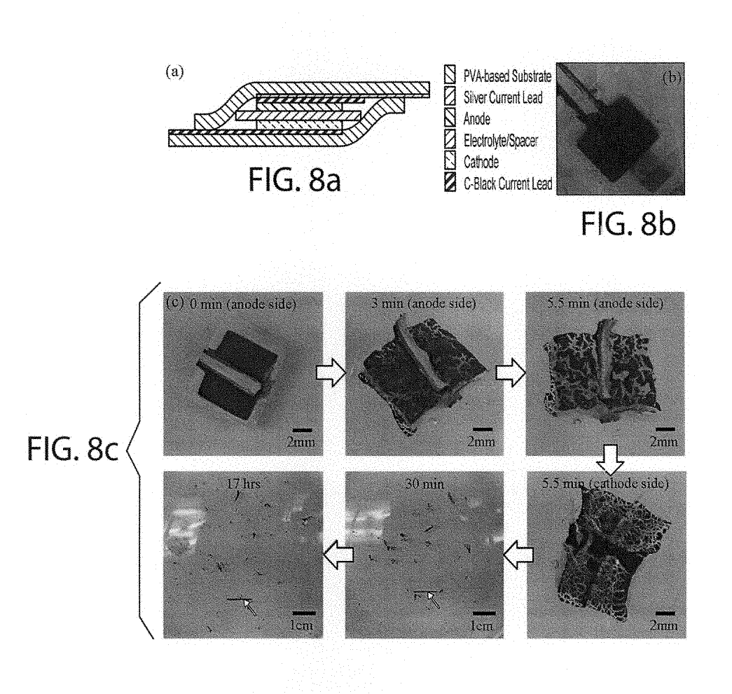

Presented in FIG. 8a is a schematic representation of cross section of a single cell battery. Electrodes were fabricated with characteristics of group 1 electrodes as presented in Table 1. Carbon black and silver paint were used for fabrication of current leads; while the silver paint has higher electrical conductivity, only carbon black was used as the cathode current lead to prevent oxidation of silver in cathode when under applied potential (charging). The single cell batteries were charged and discharged a couple of times before the transiency testing to ensure proper functionality of the battery. Heat generated during this process strengthens the bonding among the materials and slightly hindered transiency rate compare to that of single-unheated-electrodes. Thus, although active materials used in the example are most suitable for secondary cell batteries, the inventors report constructed batteries as a primary cell that requires an initial charging and can undergo a few charging/discharging cycles in practice.

To evaluate transiency of the single cell batteries (FIG. 8b), DI water at room temperature was used as a trigger (solvent). As expected from single electrode experiments, the single cell swelled and the electrodes cracked moments after exposure to the solvent; yet, it took a longer time for substrate to dissolve and active materials to redisperse. Demonstrated in FIG. 8c are sequential images of the transience of the battery. The substrate swells first witch results in physical deconstruction of the electrodes. Initially the current leads are less impacted as the thickness of those areas is greater than that of the rest of the electrode. The anode cracked into larger pieces while the cathode deconstructed into much smaller ones [see FIG. 8c at 5.5 min]. Eventually the substrate dissolved completely and electrode remains were released to roam freely in the solvent. Dissolution of the PVA binder in the active materials resulted in dispersion of milli/micrometer size particles in the solvent. After approximately 30 minutes, most of the battery was either dissolved or redispersed. Remains were left for another 16.5 hours to redisperse. Although the remaining pieces reduced in size over time, the change was incremental between the 1^{st} and 17^{th} hours. The overall transience behavior was similar to that of the single electrodes, yet expanded over a longer period of time. The extended time was anticipated to be consequent to 1) increase of the overall thickness of the battery compare to single electrode; and 2) induced bonding due to the heat generated during charging and discharging.

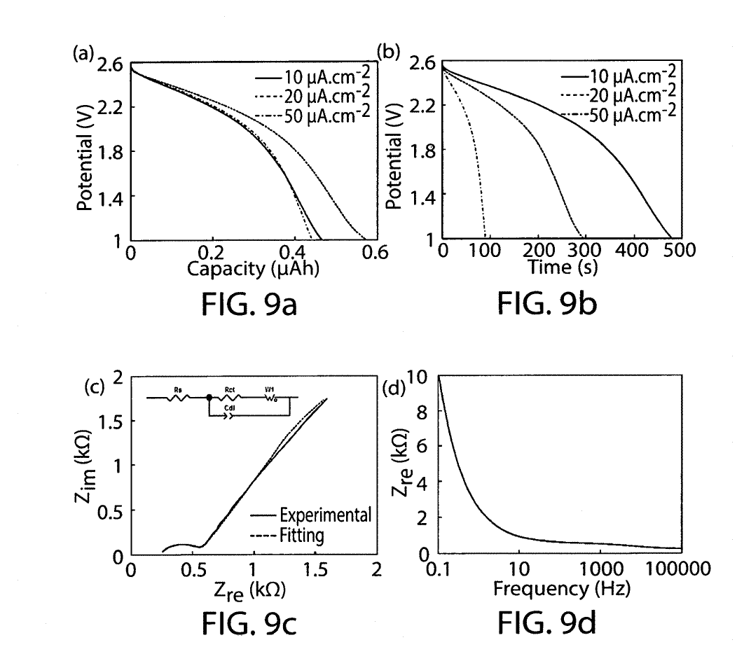

The performance of the single cell transient batteries were evaluated at different discharge current densities of 10, 20 and 50 μA·cm²; and, cut-off voltages of 2.7 V (charge) and 1.0 V (discharge). As demonstrated in FIG. 9a, the battery had comparable performances at different discharge current densities. The discharge voltages start at approximately 2.6 V, slowly decrease to 1.8 V, and then drop to 1.0 V at sharp slopes. The battery cell had the highest discharging specific capacity (about 2.27 mAh.g⁻¹) and efficiency (12.5%), and total capacity of 0.571 μAh when discharged at 20 μA·cm⁻². Typically, the discharging capacity decreases as the discharging current increases; in our study, however, the battery has higher discharging specific capacity at 20 μA·cm⁻² compared to 10 μA·cm⁻² mainly because of the relatively high internal resistance of the battery. At 50 μA·cm⁻² discharging current density the reaction time is deemed to be the limiting factor for higher discharging specific current; thus, the 20 μA·cm⁻² discharging current density exhibited the highest discharging specific capacity for this cell configuration. Shown in FIG. 9b is the discharging potential as a function of time.

FIGS. 9a and 9b show discharging behavior of transient battery cells at different current densities. FIGS. 9c and 9d show electrochemical impedance of a battery cell and the equivalent electric circuit [FIG. 9c-inset]. The battery cells were connected to a digital multi-meter to this end.

The electrochemical reactions occurring at the electrodes/electrolyte interfaces determine the electrochemical performance of the battery. To evaluate the parameters involved in the electrochemical processes, the electrochemical impedance of the battery was measured over a wide frequency range [FIGS. 9c, 9d]; an equivalent circuit was introduced based on Randles cell model to fit the data of electrochemical impedance Nyquist plot. The impedance at low frequency range (between 0.1 and 1.0 Hz) is between 10 and 2.5 kΩ (FIG. 9d). The Nyquist plot presented in FIG. 3c consists of a depressed semicircle at high frequency, which is an indication of non-uniform electrode/electrolyte interfaces, and a linear spike at low frequency. The equivalent circuit (FIG. 9c, inset) consists of two resistors: Rₛ corresponding to the ohmic resistance at high frequency and R_{ct} corresponds to the charge transfer resistance of the electrodes, a Warburg element (W1, Wₒ—Warburg open) which accounts for the diffusion reactance at low frequencies, and a constant phase element corresponding to the double layer charging (C_{dl}) at the porous electrode/electrolyte interfaces; a constant phase element is used instead of an ideal capacitor because of the depressed shape of the Nyquist semicircle. Results suggest an Rₛ value of approximately 242Ω, which includes the electrolyte resistance as well as the ohmic resistance of the battery cell and an R_{ct} of approximately 327Ω. The relatively large value of R_{ct} is presumed to be an indication of poor connection between the electrodes and electrolyte layer. While both non-uniform interfaces and presumably poor connections between the battery components may be responsible for relatively poor electrochemical performance of the presented battery cell, they are not fundamental issues and could be improved by utilization of advanced manufacturing techniques.

A battery cell was connected to a digital multi-meter and showed 2.53 V potential that is double the initial potential (prior to transiency initiation) of transient electrodes reported in the literature. A single battery cell is capable to supply enough power to power a basic calculator for a short period of time; the threshold voltage to power the calculator is about 1 V.

A transient battery cell as described above was used to power a four-function calculator. The battery and solar cell of the calculator were disconnected from the device's circuit, and the power was only supplied by the transient battery. The battery cell was able to power the calculator for approximately 15 minutes before the screen started to fade. Fabricating electrodes with higher area density or connecting several battery cells in parallel can significantly improve the performance of the battery for higher power consuming applications; yet, higher area density electrodes take longer time to deconstruct. Also, as discussed earlier, more advanced fabrication techniques can be used to improve the overall efficiency and performance of battery cells, while transiency rate can be controlled via optimization of the nano/microstructure of electrodes and substrate.

Although the invention has been described in detail above with respect to certain illustrative embodiments, those skilled in the art will appreciate that changes and modifications can be made to these embodiments without departing from the spirit and scope of the invention as set forth in the appended claims.

References which are incorporated herein by reference:

[1] H. L. Hernandez, S.-K. Kang, O. P. Lee, S.-W. Hwang, J. A. Kaitz, B. Inci, C. W. Park, S. Chung, N. R. Sottos, J. S. Moore, J. A. Rogers, S. R. White, Advanced Materials 2014, 26, 7637.

[2] C. W. Park, S.-K. Kang, H. L. Hernandez, J. A. Kaitz, D. S. Wie, J. Shin, O. P. Lee, N. R. Sottos, J. S. Moore, J. A. Rogers, S. R. White, Advanced Materials 2015, n/a.

[3] S. W. Hwang, H. Tao, D. H. Kim, H. Cheng, J. K. Song, E. Rill, M. A. Brenckle, B. Panilaitis, S. M. Won, Y. S. Kim, Y. M. Song, K. J. Yu, A. Ameen, R. Li, Y. Su, M. Yang, D. L. Kaplan, M. R. Zakin, M. J. Slepian, Y. Huang, F. G. Omenetto, J. A. Rogers, Science 2012, 337, 1640; S.-W. Hwang, G. Park, H. Cheng, J.-K. Song, S.-K. Kang, L. Yin, J.-H. Kim, F. G. Omenetto, Y. Huang, K.-M. Lee, J. A. Rogers, Advanced Materials 2014, 26, 1992.

[4] S.-W. Hwang, D.-H. Kim, H. Tao, T.-i. Kim, S. Kim, K. J. Yu, B. Panilaitis, J.-W. Jeong, J.-K. Song, F. G. Omenetto, J. A. Rogers, Advanced Functional Materials 2013, 23, 4087.

[5] M. Irimia-Vladu, Chemical Society Reviews 2014, 43, 588; M. Irimia-Vladu, E. D. Glowacki, G. Voss, S. Bauer, N. S. Sariciftci, Materials Today 2012, 15, 340.

[6] M. Irimia-Vladu, N. S. Sariciftci, S. Bauer, Journal of Materials Chemistry 2011, 21, 1350.

[7] L. Yin, H. Cheng, S. Mao, R. Haasch, Y. Liu, X. Xie, S.-W. Hwang, H. Jain, S.-K. Kang, Y. Su, R. Li, Y. Huang, J. A. Rogers, Advanced Functional Materials 2014, 24, 645.

[8] S.-W. Hwang, J.-K. Song, X. Huang, H. Cheng, S.-K. Kang, B. H. Kim, J.-H. Kim, S. Yu, Y. Huang, J. A. Rogers, Advanced Materials 2014, 26, 3905.

[9] S.-W. Hwang, H. Tao, D.-H. Kim, H. Cheng, J.-K. Song, E. Rill, M. A. Brenckle, B. Panilaitis, S. M. Won, Y.-S. Kim, Y. M. Song, K. J. Yu, A. Ameen, R. Li, Y. Su, M. Yang, D. L. Kaplan, M. R. Zakin, M. J. Slepian, Y. Huang, F. G. Omenetto, J. A. Rogers, Science 2012, 337, 1640.

[10] R. Li, H. Cheng, Y. Su, S.-W. Hwang, L. Yin, H. Tao, M. A. Brenckle, D.-H. Kim, F. G. Omenetto, J. A. Rogers, Y. Huang, Advanced Functional Materials 2013, 23, 3106.

[11] L. Mengdi, A. W. Martinez, S. Chao, F. Herrault, M. G. Allen, Microelectromechanical Systems, Journal of 2014, 23, 4.

[12] S: W. Hwang, G. Park, C. Edwards, E. A. Corbin, S.-K. Kang, H. Cheng, J.-K. Song, J.-H. Kim, S. Yu, J. Ng, J. E. Lee, J. Kim, C. Yee, B. Bhaduri, Y. Su, F. G. Omennetto, Y. Huang, R. Bashir, L. Goddard, G. Popescu, K.-M. Lee, J. A. Rogers, ACS Nano 2014, 8, 5843.

[13] S.-K. Kang, S.-W. Hwang, H. Cheng, S. Yu, B. H. Kim, J.-H. Kim, Y. Huang, J. A. Rogers, Advanced Functional Materials 2014, 24, 4427.

[14] H. Tao, M. A. Brenckle, M. Yang, J. Zhang, M. Liu, S. M. Siebert, R. D. Averitt, M. S. Mannoor, M. C. McAlpine, J. A. Rogers, D. L. Kaplan, F. G. Omenetto, Advanced Materials 2012, 24, 1067.

[15] C. J. Bettinger, Z. Bao, Advanced Materials 2010, 22, 651.

[16] X. Huang, Y. Liu, H. Cheng, W.-J. Shin, J. A. Fan, Z. Liu, C.-J. Lu, G.-W. Kong, K. Chen, D. Patnaik, S.-H. Lee, S. Hage-Ali, Y. Huang, J. A. Rogers, Advanced Functional Materials 2014, 24, 3846.

[17] G. Mattana, A. Marette, A. Vasquez Quintero, D. Briand, N. F. de Rooij, Organic Electronics.

[18] Y. J. Kim, S.-E. Chun, J. Whitacre, C. J. Bettinger, Journal of Materials Chemistry B 2013, 1, 3781.

[19] H. Acar, S. cmar, M. Thunga, M. R. Kessler, N. Hashemi, R. Montazami, Advanced Functional Materials 2014, n/a.

[20] A. H. Najafabadi, A. Tamayol, N. Annabi, M. Ochoa, P. Mostafalu, M. Akbari, M. Nikkhah, R. Rahimi, M. R. Dokmeci, S. Sonkusale, B. Ziaie, A. Khademhosseini, Advanced Materials 2014, 26, 5823.

[21] L. Yin, A. B. Farimani, K. Min, N. Vishal, J. Lam, Y. K. Lee, N. R. Aluru, J. A. Rogers, Advanced Materials 2015, 27, 1857.

[22] B. A. Miller-Chou, J. L. Koenig, Progress in Polymer Science 2003, 28, 1223.

[23] M. Bercea, S. Morariu, D. Rusu, Soft Matter 2013, 9, 1244; B. Briscoe, P. Luckham, S. Zhu, Polymer 2000, 41, 3851.

[24] S. K. Mallapragada, N. A. Peppas, Journal of Polymer Science Part B: Polymer Physics 1996, 34, 1339.

We claim:

1. Transient electronic device, comprising a transient substrate having an electronic component constructed thereon, wherein the electronic component comprises colloidal metallic particles that are initially deposited from a colloidal dispersion on the substrate to construct the electronic component on the substrate and that are subsequently re-dispersible in a solvent-containing medium to deconstruct the electronic component of the electronic device.

2. The device of claim wherein the substrate and the electronic component are concurrently deconstructible in the solvent-containing medium.

3. The device of claim 1 wherein the substrate comprises a soluble polymer.

4. The device of claim 3 wherein the soluble polymer is modified with a transiency-controlling agent.

5. The device of claim 1 wherein the metallic particles comprise an insoluble metal or alloy.

6. The device of claim 4 wherein the metallic particles comprise a noble metal or copper.

7. The device of claim 1 which is a battery.

8. The device of claim 7 which is a lithium ion battery.

9. A method comprising depositing colloidal metallic particles on a transient substrate to construct an electronic component thereon to form an electronic device.

10. The method of claim 9 including the further step of contacting the electronic device with a solvent-containing medium to re-disperse the metallic particles therein and deconstruct the electronic component of the electronic device.

11. The method of claim 10 wherein the solvent-containing medium comprises water, a water-containing solvent, or a bodily fluid.

12. The method of claim 9 wherein the transient substrate and the electronic component concurrently deconstruct in the solvent-containing medium.
